(19) United States
(12) Patent Application Publication
(10) Pub. No.: US 2009/0100171 A1
(43) Pub. Date: Apr. 16, 2009

(54) PROVIDING A USER OF AN INSTANT MESSAGE CLIENT WITH AN OVER-SHOULDER STATUS

(75) Inventors: Thomas R. Haynes, Apex, NC (US); Lin Sun, Morrisville, NC (US)

Correspondence Address: STRATEGIC PATENT GROUP, P.C., P.O. BOX 1329, MOUNTAIN VIEW, CA, 94042, US

(73) Assignee: International Business Machines Corporation, Armonk, NY (US)

(21) Appl. No.: 11/872,558

(22) Filed: Oct. 15, 2007

(51) Int. Cl. G06F 15/173

(52) U.S. Cl. 709/224

(57) ABSTRACT

In an instant message (IM) method and system, a user of an IM client is provided with an over-shoulder status indicating the user has a visitor. The method and system further include receiving a preference setting for an over-shoulder status for defining an over-shoulder status toggle input. Mouse and keyboard strokes entered into the IM client by the user are then monitored in real-time. In response to any of the mouse and keyboard strokes matching the toggle input, the over-shoulder status is automatically toggled, whereby the over-shoulder status is updated in a contact list of at least one other IM client, such that activation of the over-shoulder status serves as a warning that the user has a visitor.

### BACKGROUND OF THE INVENTION

Instant messaging (IM) applications have become the most prevalent means of communication in recent years. This use of IM has been increasingly pervasive, and is now commonly used among users within businesses, where information can be very sensitive and any disclosure of unintended information could be damaging. Oftentimes, a user may have an IM client launched on his computer while a visitor stops by his office. It could be embarrassing to the user or a breach of company security if an IM window unexpectedly pops-up containing sensitive information while the visitor is on-looking. The user could simply close the IM client at this point, but in some situations, the user does not wish to alert the visitor that a potential breach has, or will occur, or otherwise make the visitor feel un-trusted.

### BRIEF SUMMARY OF THE INVENTION

In an instant message (IM) method and system, a user of an IM client is provided with an over-shoulder status indicating the user has a visitor. The method and system further include receiving a preference setting for an over-shoulder status for defining an over-shoulder status toggle input. Mouse and keyboard strokes entered into the IM client by the user are then monitored in real-time. In response to any of the mouse and keyboard strokes matching the toggle input, the over-shoulder status is automatically toggled, whereby the over-shoulder status is updated in a contact list of at least one other IM client, such that activation of the over-shoulder status serves as a warning that the user has a visitor.

### BRIEF DESCRIPTION OF THE DRAWINGS

FIG. 1 is a logical block diagram illustrating an exemplary network system environment in which one embodiment of the present invention for providing a user of an IM client with an over-shoulder status may be implemented.

FIG. 2 is a diagram illustrating a process for providing a user of the IM client with the over-shoulder IM status according to an exemplary embodiment.

FIG. 3 is a diagram illustrating a warning message displayed in response to detecting the sending of an IM to a user who is in over-shoulder status.

### DETAILED DESCRIPTION OF THE INVENTION

The present invention relates to a method for providing an instant message status indicating a user of an instant message client has a visitor present. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

The exemplary embodiment of the present invention provides a new instant message (IM) status indicating an over-shoulder situation and a method for discreetly changing the status thereof. The method allows the user to discreetly change his or her IM status to an over-shoulder status, which warns other IM users that the user has a visitor, while minimizing the chances that the visitor is alerted to the change in the user's IM status.

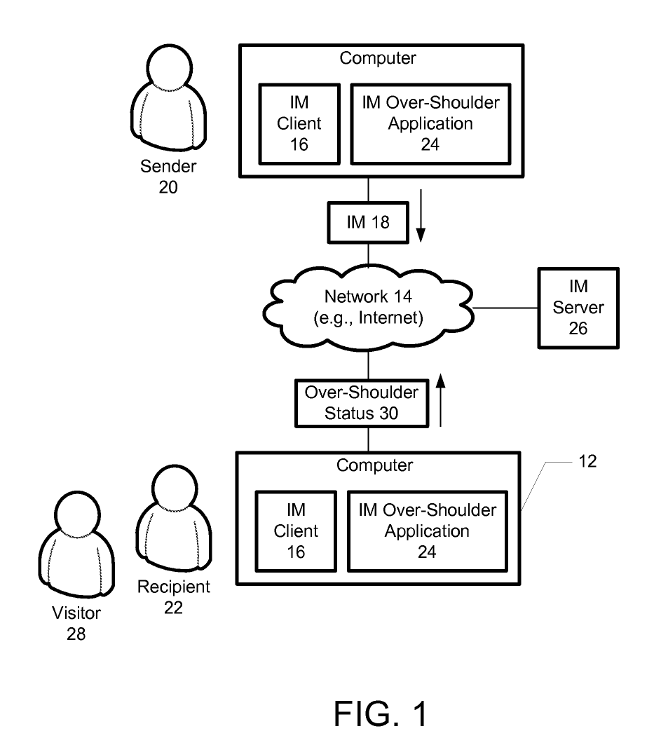

FIG. 1 is a logical block diagram illustrating an exemplary network system environment in which one embodiment of the present invention for providing an over-shoulder IM status may be implemented. A network system environment 10 is shown in which two or more computers 12 communicate over a network 14. The network 14 may be a public network, such as the Internet, or a private network, such as an intranet, LAN, or WLAN, or a combination of the above. At least a portion of the computers 12 may execute corresponding messaging clients, such as instant messaging (IM) clients 16. As is well-known, IM clients 16 allow real-time communication between two or more users through the transmissions of text-based messages between the IM clients 16 of networked computers 12. The messages, which are referred to as instant messages 18, are typically text-based, but the instant messages 18 may also include voice, digital images, and video.

The IM client 16 allows a user to exchange instant messages (IM) 18 with one or more other users listed on the user's contact or buddy list (not shown). Once invoked, the IM client 16 may connect with a server 26 as part of an instant messaging service. After logging-in and establishing a connection, the IM client 16 requests connection information and status of the users in the contact list. Once the server 26 returns the requested information, the IM client 16 displays the online status of the users in the contact list to indicate who is ready to chat. When the status of each user changes, the corresponding status is automatically updated in the contact list. The default IM status is “online”, but the status of any online user can be changed to be more specific. Example online statuses may include “available”, “busy”, “away”, “idle” and “on the phone”, for example.

To send an IM 18, the user clicks on the name of another online user from the contact list, and in response, the IM client opens a window that the user can enter text into. The user enters a message and clicks “send” or hits return to send the IM 18 to that user. When sending the IM 18, the user may be referred to as the sender 20 and the person receiving the IM 18 may be referred to as the recipient 22. When the recipient 22 receives the IM 18, the recipient's IM client 16 opens a scrolling window for displaying the IM thread that displays the received IM 18 as well as a pane for the user to compose a reply to each received IM 18.

When individual users use IM clients 16 in a workplace environment, the adoption of IM for use as a business communication medium can have unintended consequences. As stated above, if a user has the IM client 16 active while in the presence of a visitor 28, the user/recipient 22 could face potential embarrassment or the company could face a potential security breach if an IM window unexpectedly pops-up containing sensitive information while the visitor 28 is on-looking. Another example of where the user may wish to avoid a potentially embarrassing situation is a social chat user, such as a teenager, who may also have concerns while receiving an IM 18 while in the presence of an on-looker at a coffee shop or at home, for example. When faced with such a visitor 28, the user could simply close the IM client 16 at this point, but in some situations, the user does not wish to alert the visitor 28 that a potential breach has, or will occur, or otherwise make the visitor feel un-trusted or uncomfortable.

According to the exemplary embodiment, the inventors of the present invention recognize that in such a situation, it would be more desirable to warn the other IM users about the visitor 28. Although conventional IM clients provide several status choices for indicating status of the user, this situation cannot be easily prevented with current IM status choices, such available, away, and busy.

Accordingly, the exemplary embodiment allows the user of the IM client 16 to indicate a new IM status to make other IM users aware that there is a visitor 28 in the presence of the user. This new IM status, referred to herein as, “over-shoulder” status 30, functions as a warning to other online users that the user has a visitor and that the users should be careful what content they include in any IM 18 sent to the user, if any, while the user is in the over-shoulder status 30.

Although some conventional IM services may allow the creation of a custom status, the process is somewhat involved. For example, the creation of a custom status typically requires the use to first navigate a menu within the IM client and select an option to create a new status message. Next, the user may have to type in the custom status message (such as “visitor over my shoulder”), and then click an “OK” button. Therefore, the user cannot easily create a custom over-shoulder status for the above situation using conventional methods without alerting the visitor 28 that something is amiss. That is, by the user taking this series of steps to create a custom status, the visitor 28 will easily see that the user is attempting to warn others of his or her presence.

Accordingly, a further aspect of the exemplary embodiment provides an IM over-shoulder application 24 for allowing the user to discreetly enter and exit (toggle on/off) the over-shoulder status without alerting the visitor 28. The IM over-shoulder application 24 allows the user to create and maintain preferences for the over-shoulder status 30, as explained below. The IM over-shoulder application 24 may be implemented as part of a customized IM client 16 or as a plug-in to an existing IM client 16. The IM over-shoulder application 24 may be provided as part of existing instant messaging service, or provided by third-party.

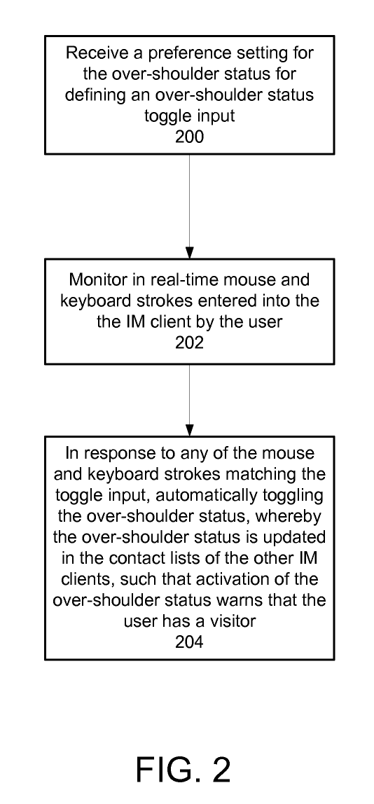

FIG. 2 is a diagram illustrating a process for providing an instant message status indicating a user of IM client has a visitor according to an exemplary embodiment. The process begins in step 200 by the IM over-shoulder application 24 receiving a preference setting for the over-shoulder status 30 that includes a parameter for defining an over-shoulder status toggle input. The over-shoulder status toggle input defines a mouse and/or keyboard sequence for discreetly activating/deactivating the over-shoulder status 30, where discretely means to minimize the chance that the visitor 28 will notice or be alerted to that the user is changing status. As used herein, the term mouse is used as shorthand for any type of computer input pointing device.

The preference setting may also include a parameter for defining how an IM status indicator displays the over-shoulder status; a parameter for displaying a warning message to any other users who attempt to send the current user an IM 18 while his over-shoulder status 30 is active; and a parameter for defining an action the IM client 16 should automatically perform when an IM 18 is received while the over-shoulder status 30 is active. In one embodiment, the IM over-shoulder application 24 may receive the preference setting from the user of the IM client 16, or from a third party, such an enterprise system administrator. In another embodiment, the preference setting may be provided as part of the IM client 16 or the IM over-shoulder application 24 as a default set of preferences.

In one embodiment, the preferences for the over-shoulder status 30 may set through the IM client 16 (or alternatively through the IM over-shoulder application 24) by the user accessing a preference screen and selecting a “Over-Shoulder Status” option/tab. In response, a dialog may be opened that allows the user to “Create” or “Update” Over-Shoulder Preferences. If the user chooses “Create”, a dialog box may open that allows the user to select from a group of predefined mouse and keyboard sequences for toggling the over-shoulder status 30. The user may also be given an option for selecting IM status indicators to display on the user's computer and other users' computers when the over-shoulder status 30 is active; and options to select whether other users should see warning messages prior to sending an IM 18 and what action(s) should be performed in the event that an IM 18 is received while the over-shoulder status 30 is active.

In step 202, the IM over-shoulder application 24 monitors in real-time mouse and keyboard strokes entered into the IM client 16 by the user. The user of the IM client 16 may attempt to enter the over-shoulder toggle input into the IM client 16 as soon as the undesired visitor 28 appeared. According to the exemplary embodiment, the method used to allow the user to toggle the over-shoulder status 30 needs to be easy and discreet so as not to be obvious to the visitor 28. According to the exemplary embodiment, mouse clicks and keyboard sequences are used to toggle the over-shoulder status 30 without interaction with menus displayed by the IM client 16. For example, in one embodiment the IM over-shoulder application 24 may toggle the over-shoulder status 30 in response to detecting a double left mouse click of an IM icon displayed on the computer desktop. An example keyboard sequence may include the user typing-in a secret keyword into the IM composition window, which although meaningless to the onlooker, when detected by the IM over-shoulder application 24, toggles the user's status to the over-shoulder status 30.

In step 204, in response to any of the mouse and keyboard strokes matching the toggle input, the IM over-shoulder application 24 automatically toggles the over-shoulder status 30, whereby the over-shoulder status 30 is updated in the contact lists of the other IM clients, such that activation of the over-shoulder status 30 warns that the user has a visitor 28. Toggling the over-shoulder status 30 comprises activating the over-shoulder status 30 if the over-shoulder status 30 is inactive, and deactivating the over-shoulder status 30 if the over-shoulder status 30 is active. When the over-shoulder status 30 is deactivated, the user's IM status may be returned to a default “online” status, or returned to a status immediately preceding activation of the over-shoulder status 30.

In a further embodiment, the preference setting may be set such in response to detecting the toggle input, the user is provided with a brief, transient audio or video signal to indicate that the toggle input was received. For example, the IM status icon could flash once, or the IM client 16 could beep. If the mouse or keyboard supports force feedback, then the mouse or keyboard could vibrate, which should go unnoticed by the visitor 28.

Depending on the setting of the parameter defining the IM status indicator, when the over-shoulder status 30 is activated, the IM icon displayed by the IM client 16 may be kept unchanged or varied slightly from that of the regular online status icon so that the visitor 28 can not tell from viewing the interface of the IM client 16 that the user's IM status has changed (that is, remain oblivious to the fact that the user has turned it on).

However, in one embodiment, the user may configure his status indicator such that the IM icon is displayed noticeably different on the IM client 16 of other user's when the user is in the over-shoulder status 30 than when the user is in the regular online status. In this regard, the new over-shoulder status 30 can be combined with traditional status choices to create a hybrid status, such as “In a meeting, over shoulder”, for example

In a further embodiment, the preference setting may also cause other users' IM clients 16 to display a warning message when the users/senders 20 attempts to send an IM 18 to any user who currently has an active over-shoulder status 30. If the warning message is displayed, the sender 20 may be provided with a choice to override the non-transmission of an IM message.

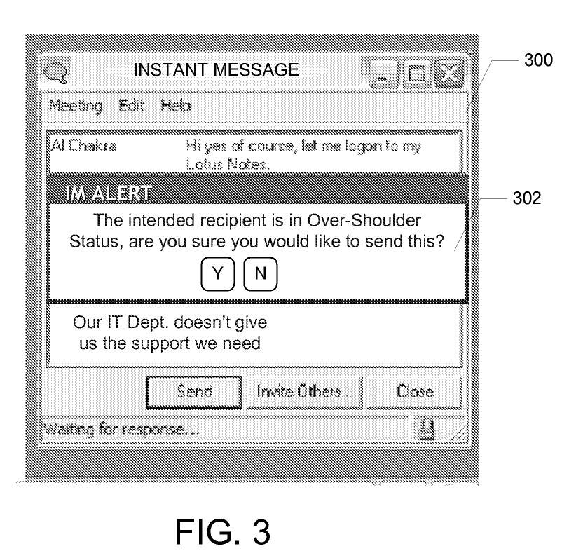

FIG. 3 is a diagram illustrating a warning message displayed in response to detecting the sending of an IM to a user who is in over-shoulder status. In this example, the sender 20 has entered a message into an IM window 300 that is addressed to a recipient 22 who is an over-shoulder status 30. Upon detection of this attempted IM transmission, the IM over-shoulder application 24 halts transmission of the IM 18 and displays a warning message window 302 warning the sender 20 of the recipient's 22 over-shoulder status 30 and prompting the sender 20 to select whether they wish to proceed with sending the IM 18 or not. Thus, the IM over-shoulder application 24 provides the user with a choice of overriding the halt of the message transmission by sending the message as is, or to edit the message before attempting to resend the message. In one embodiment, this override feature can be an option that is set within the over-shoulder status preferences.

In another embodiment, the user has the option of setting the parameter in the preferences for defining an action the IM client 16 should automatically perform if an IM 18 is received while the over-shoulder status 30 is active. On example action is to automatically minimize the IM window 300 upon receipt of the IM 18, rather than pop-up the IM window 300 for the visitor 28 to see. Another example action is to deny receipt of the IM 18 altogether, similar to an offline status.

In another embodiment, if the user cannot remember or tell if he is the over-shoulder status 30, since the IM status indicator may not indicate such, then the user may be use the toggle input and toggle to the desired IM status, or the user's IM status may be viewed within in the IM client's menu structure. In one embodiment, the IM over-shoulder application 24 may be configured to send the user a message via e-mail or IM 18 to remind the user to deactivate the over-shoulder status 30 once a preconfigured time threshold has passed.

A system of method for providing a user of an IM client with an over-shoulder status indicating the user has a visitor has been disclosed. The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The present invention has been described in accordance with the embodiments shown, and one of ordinary skill in the art will readily recognize that there could be variations to the embodiments, and any variations would be within the spirit and scope of the present invention. Accordingly, many modifications may be made by one of ordinary skill in the art without departing from the spirit and scope of the appended claims.

We claim:

1. A method for providing a user of an instant message (IM) client with an over-shoulder status indicating the user has a visitor, the method comprising:
receiving a preference setting for the over-shoulder status for defining an over-shoulder status toggle input;
monitoring in real-time mouse and keyboard strokes entered into the IM client by the user; and
in response to any of the mouse and keyboard strokes matching the over-shoulder status toggle input, automatically toggling the over-shoulder status, whereby the over-shoulder status is updated in a contact list of at least one other IM client, such that activation of the over-shoulder status serves as a warning about the visitor.

2. The method of claim 1 wherein the preference setting further includes a parameter for defining an action the IM client should automatically perform if a message is received while the over-shoulder status is active.

3. The method of claim 2 wherein the action comprises minimizing an IM window displayed by the IM client upon receipt of the message.

4. The method of claim 1 further comprising providing the user with a transient signal to indicate that the over-shoulder status toggle input was received.

5. The method of claim 1 wherein automatically toggling the over-shoulder status further comprises activating the over-shoulder status if the over-shoulder status is inactive, and deactivating the over-shoulder status if the over-shoulder status is active.

6. The method of claim 5 wherein when the over-shoulder status is activated, keeping an IM icon of the user that is displayed by the IM client unchanged from that of a regular online status icon so that the visitor can not tell from viewing the IM client that the user's IM status has changed.

7. The method of claim 6 wherein the user's IM icon is configurable such that the IM icon displayed by the IM client is displayed differently by the at least one other IM client.

8. The method of claim 1 wherein when the over-shoulder status is active, causing the at least one other IM client to display a warning message to at least one other user when at least one other user attempts to send a message to the user.

9. The method of claim 1 further comprising sending the user a message to remind the user to deactivate the over-shoulder status once a preconfigured time threshold has passed.

10. An executable software product stored on a computer-readable medium containing program instructions for providing a user of an instant message (IM) client with an over-shoulder status indicating the user has a visitor, the program instructions for:
receiving a preference setting for the over-shoulder status for defining an over-shoulder status toggle input;
monitoring in real-time mouse and keyboard strokes entered into the IM client by the user; and
in response to any of the mouse and keyboard strokes matching the over-shoulder status toggle input, automatically toggling the over-shoulder status, whereby the over-shoulder status is updated in a contact list of at least one other IM client, such that activation of the over-shoulder status serves as a warning about the visitor.

11. The executable software product of claim 10 wherein the preference setting further includes a parameter for defining an action the IM client should automatically perform if a message is received while the over-shoulder status is active.

12. The executable software product of claim 11 wherein the action comprises minimizing an IM window displayed by the IM client upon receipt of the message.

13. The executable software product of claim 10 further comprising providing the user with a transient signal to indicate that the over-shoulder status toggle input was received.

14. The executable software product of claim 10 wherein automatically toggling the over-shoulder status further comprises activating the over-shoulder status if the over-shoulder status is inactive, and deactivating the over-shoulder status if the over-shoulder status is active.

15. The executable software product of claim 14 wherein when the over-shoulder status is activated, keeping an IM icon of the user that is displayed by the IM client unchanged from that of a regular online status icon so that the visitor can not tell from viewing the IM client that the user's IM status has changed.

16. The executable software product of claim 15 wherein the user's IM icon is configurable such that the IM icon displayed by the IM client is displayed differently by the at least one other IM client.

17. The executable software product of claim 10 wherein when the over-shoulder status is active, causing the at least one other IM client to display a warning message to at least one other user when at least one other user attempts to send a message to the user.

18. The executable software product of claim 10 further comprising sending the user a message to remind the user to deactivate the over-shoulder status once a preconfigured time threshold has passed.

19. A messaging system comprising:
a server coupled to a network;
a first messaging client executing on a first computer in communication with the server; and
a second messaging client executing on a second computer in communication with the server;
wherein the at least the first messaging client performs functions for:
receiving a preference setting for an over-shoulder status for defining an over-shoulder status toggle input;
monitoring in real-time mouse and keyboard strokes entered into the first messaging client by a first user; and
in response to any of the mouse and keyboard strokes matching the over-shoulder status toggle input, automatically toggling the over-shoulder status, whereby the over-shoulder status is updated in a contact list of the second messaging client, such that activation of the over-shoulder status warns a second user of the second messaging client that the first user of the first messaging client has a visitor.
